(19) United States
(12) Patent Application Publication
(10) Pub. No.: US 2015/0062776 A1
(43) Pub. Date: Mar. 5, 2015

(54) SUPERCAPACITOR WITH A CORE-SHELL ELECTRODE

(71) Applicant: Feng Chia University, Taichung City (TW)

(72) Inventors: Kuo-Feng CHIU, Taichung City (TW); Shi-Kun CHEN, Taichung City (TW); Tze-Hao KO, Taichung City (TW)

(73) Assignee: Feng Chia University, Taichung City (TW)

(21) Appl. No.: 14/066,746

(22) Filed: Oct. 30, 2013

(30) Foreign Application Priority Data
Aug. 29, 2013 (TW) 102130961

(51) Int. Cl. H01G 11/24

(52) U.S. Cl. CPC H01G 11/24
USPC 361/502

(57) ABSTRACT

A supercapacitor includes a pair of electrodes and an electrolyte. Each electrode has a graphite fiber core, and an activated carbon shell atomically coated on an outer surface of the core. The electrolyte is mounted between the two electrodes and in touch with each shell for electrical connection of the two electrodes.

### CROSS REFERENCE

The non-provisional application claims priority from Taiwan Patent Application NO. 102130961, filed on Aug. 29, 2013, the content thereof is incorporated by reference herein.

### FIELD OF THE INVENTION

The invention relates to a supercapacitor, and particularly to a supercapacitor with a core-shell electrode.

### BACKGROUND OF THE INVENTION

A supercapacitor, also called an electrochemical capacitor (EC) or an electric double layer capacitor (EDLC), works as follows:

When charged, an electrode surface of the supercapacitor holds a positive charge, and another surface of the supercapacitor electrode holds a negative charge. The positive charge can attract an anion within an electrolyte of the supercapacitor, and the negative charge can attract a cation within the electrolyte, so an electric potential is formed among these attracted ions. When discharged, the positive charge and the negative charge are out of these electrode surfaces. The anion attracted by the positive charge and the cation attracted by the negative charge are back to the electrolyte, the electric potential so formed is released. A supercapacitor has a greater power density, a longer charge/discharge cycle, a shorter charging period, and a longer electricity storage period than a conventional battery, and a greater energy density as well as a longer discharging period than a conventional capacitor. For at least these reasons, the supercapacitor has replaced these conventional devices to supply electricity with an electric device.

The inventors have disclosed a supercapacitor, which includes a solid polymer electrolyte and a modified carbonaceous electrode. The carbonaceous electrode is made via a process of coating an active material on a conductive carbonaceous substrate. The active material comprises a conductive additive and an adhesive to allow the conductive additive to adhere to the conductive carbonaceous substrate. However, its electrode exhibits high electric impedance because of the adhesive, and there is a need for improving the electric efficiency of the disclosed supercapacitor. Additionally, the manufacture of the electrode is complicated due to the adhesive.

Accordingly, it is desired to design a supercapacitor which can decrease electric impedance of its electrode and simplify the manufacture of the electrode.

### SUMMARY OF THE INVENTION

An objective of one embodiment of the invention is to provide a novel supercapacitor, and the supercapacitor includes a pair of electrodes and an electrolyte. Each electrode has a graphite fiber core, and an activated carbon shell atomically coated on an outer surface of the core. The electrolyte is mounted between the two electrodes and in touch with each shell of the two electrodes for electrical connection of the two electrodes.

According to the embodiment of the invention, the shell is atomically coated on the outer surface of the core without any adhesive to help the shell adhere on the outer surface. In such a manner, electric impedance of the electrodes is decreased. And the manufacture of the electrodes is also simplified because of the removal of adhesive.

### BRIEF DESCRIPTION OF THE DRAWINGS

FIG. 1 is a section view illustrating a supercapacitor in accordance with an embodiment of the invention.

FIG. 2 is a section view illustrating a supercapacitor in accordance with another embodiment of the invention.

FIG. 3 is a scanning electron microscopic image illustrating the appearance of a graphite fiber in an example.

FIG. 4 is a scanning electron microscopic image illustrating the appearance of an electrode in the example.

FIG. 5 shows self-discharge rates of a supercapacitor in the example and a prior supercapacitor.

FIG. 6 shows gravimetric capacity of the supercapacitor and a prior lithium-ion battery.

FIG. 7 shows volumetric capacity of the supercapacitor and the prior lithium-ion battery.

### DETAILED DESCRIPTION OF THE INVENTION

The detailed description and preferred embodiment of the invention will be set forth in the following content, and provided for people skilled in the art so as to understand the characteristics of the invention.

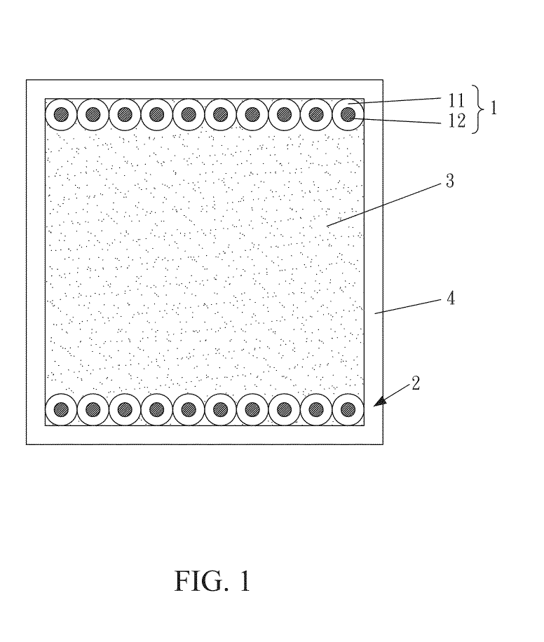

A supercapacitor in accordance with an embodiment of the invention is depicted in FIG. 1. The supercapacitor comprises an upper electrode (1), a bottom electrode (2), an electrolyte (3), and a package (4).

The upper electrode (1) has a graphite fiber core (12) and an activated carbon shell (11) atomically coated on an outer surface of the graphite fiber core (12). The phrase “atomically coated” used in the content indicates that a carbon atom of the activated carbon shell (11) and a carbon atom of the graphite fiber core (12) are linked to form a carbon-carbon bond, and the shell (11) is coated on the outer surface through the carbon-carbon bond. In this embodiment, the diameter of the graphite fiber core (12) is approximately of 100 μm to 500 μm, and the depth of the activated carbon shell (11) is approximately of 1 nm to 50 nm.

The upper electrode (1) may be produced via a hot acid bathing process or a plasma induction process. In the hot acid bathing process, an outer surface of a graphite fiber is treated with hot acid, such as nitric acid, to convert into an activated carbon, and then the upper electrode (1) is formed. In the plasma induction process, a graphite fiber is clamped with two plasma electrodes. After that, one of the plasma electrodes is applied with a high-frequency pulse under an atmosphere, and the other is grounded. Finally, pores of the graphite fiber are full of a microplasma, and the plasma makes an outer surface of the graphite fiber converted into an activated carbon so that the upper electrode (1) is formed. In the embodiment, the voltage of the pulse is approximately of ±200 V to ±400 V, the frequency of the pulse is approximately of 1 kHz to 50 kHz, the atmosphere is, not limited to, nitrogen gas, inert gas, or dry air, and the pressure of the atmosphere is approximately of 0.05 torr to 0.5 torr.

Compared with the hot acid bathing process, the plasma induction process is more preferably introduced to form the upper electrode (11), which results from that the depth of the shell (11) can be controlled by adjusting the foregoing and/or other parameters of the plasma induction process.

The bottom electrode (2) has a structure described with reference to that of the upper electrode (1), and is also produced with reference to the manufacture of the upper electrode (1).

The electrolyte (3) is positioned between the upper electrode (1) and the bottom electrode (2) and in touch with the activated carbon shells (11) of the two electrodes (1, 2). As such, the upper electrode (1) and the bottom electrode (2) are electrically connected. In this embodiment, the electrolyte (3) is a solid electrolyte, and the solid electrolyte is made of, not limited to, a conductive polymer, or a mixture containing the conductive polymer and an ionic compound. An example of the conductive polymer is polyethene, polyaniline, polypyrrole, polythiophene, or poly(p-phenylenevinylene).

The package (4) is provided to accommodate the two electrodes (1, 2) and the electrolyte (3). The package (4) may be made of aluminum, aluminum alloy, or a thermostable resin (e.g. an epoxy resin, a phenol resin, or a polyimide resin).

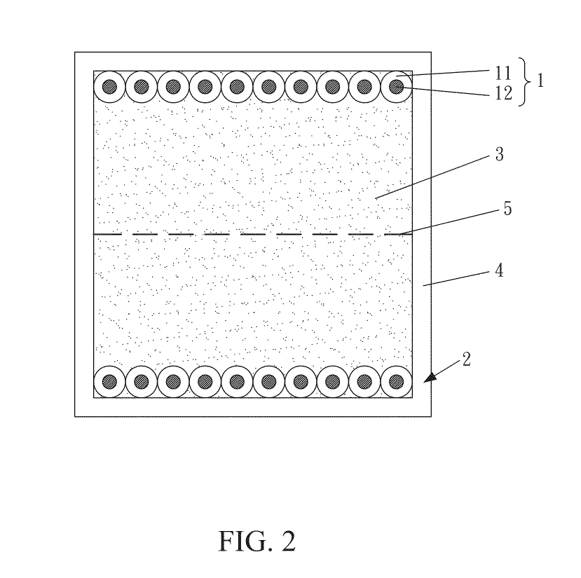

A supercapacitor in accordance with another embodiment of the invention is shown in FIG. 2. The supercapacitor has a feature identical to that of the supercapacitor of the first embodiment, except for below features:

The electrolyte (3) is a liquid electrolyte, and the liquid electrolyte is made of, not limited to, a solution containing a metal salt of group IA, or a molten salt of group IA.

In order to avoid the electrodes (1, 2) from short circuit, the supercapacitor further includes an isolation membrane (5). The membrane (5) is provided in the electrolyte (3) to isolate the upper electrode (1) from the bottom electrode (2). An example of the membrane (5) is, not limited to, a polyalkane non-woven fabric, a polyvinylchloride micro-porous membrane, an ebonite micro-porous membrane, or a glass fiber membrane.

The package (4) is provided to accommodate the two electrodes (1, 2), the electrolyte (3), and the isolation membrane (5).

The following examples are offered to further illustrate the invention.

### Example

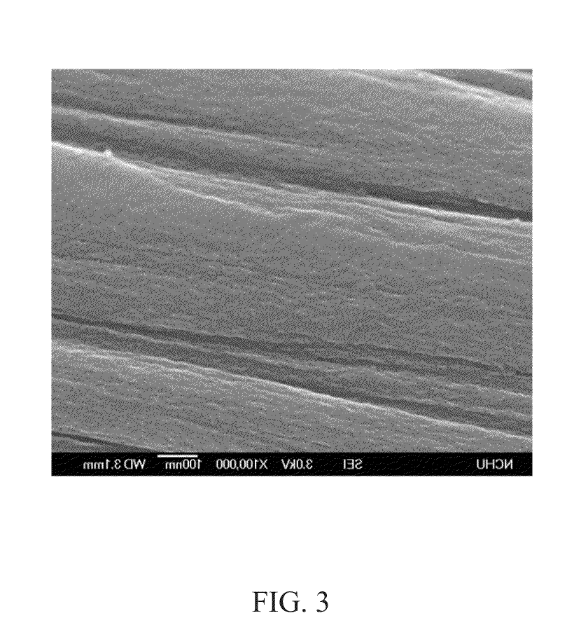

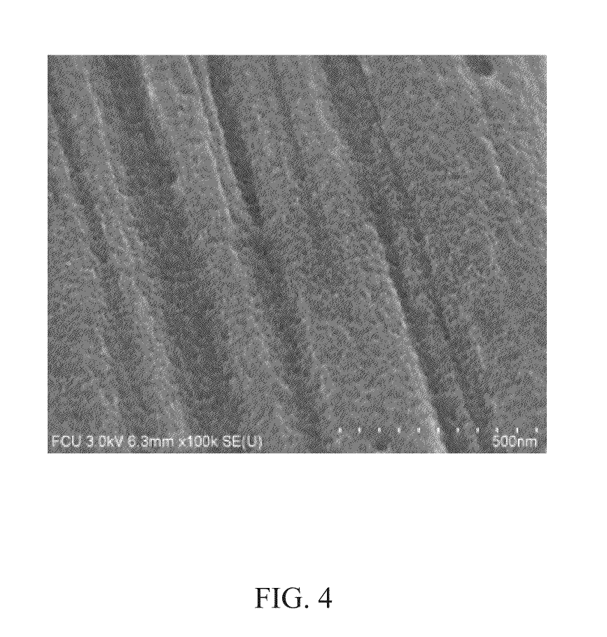

First, a graphite fiber shown in FIG. 3 is clamped with two plasma electrodes. One of the plasma electrodes is applied with a high-frequency pulse having a voltage of ±200 V to ±400 V, and a frequency of 1 kHz to 50 kHz under 0.05 torr to 0.5 torr of nitrogen gas, inert gas, or dry air; the other one is grounded. Pores of the graphite fiber are full of a microplasma, and then the plasma renders an outer surface of the graphite fiber become an activated carbon so as to form an electrode shown in FIG. 4. In other words, the formed electrode has a graphite fiber core and an activated carbon shell, the core originates from the interior of the graphite fiber, and the shell originates from the outer surface of the graphite fiber and is atomically coated on the outer surface of the core.

After which, two electrodes as above and an electrolyte are taken and mounted into a package to obtain a supercapacitor, where the electrolyte is mounted between the two electrodes and in touch with each shell of the two electrodes.

### Analysis

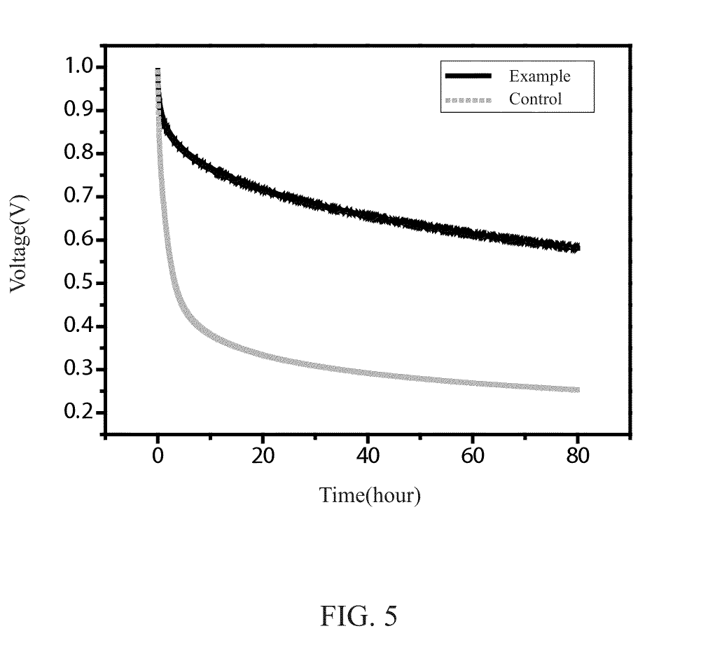

To determine the self-discharge rate of the supercapacitor thus obtained, the supercapacitor and a prior supercapacitor (as control) are both charged to a voltage of 1V, and then their remaining voltages are measured after they standing at open circuit condition for a period. As shown in FIG. 5, after they standing for 80 hours, the remaining voltage of the supercapacitor in the example is of 0.6V, and that of the prior supercapacitor is of 0.25V. This demonstrates that the supercapacitor in the example has a relatively low self-discharge rate. That is, the supercapacitor in the example has a relatively long electricity storage period.

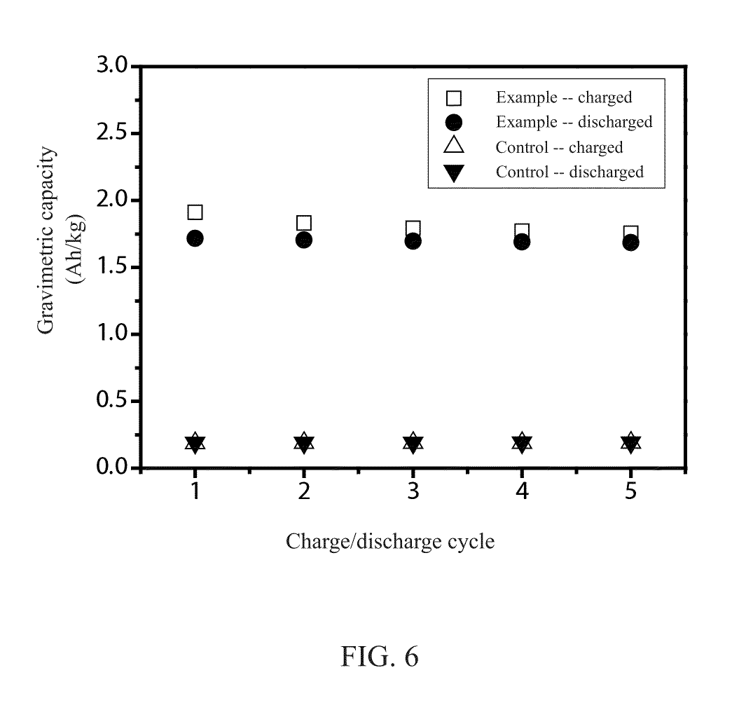

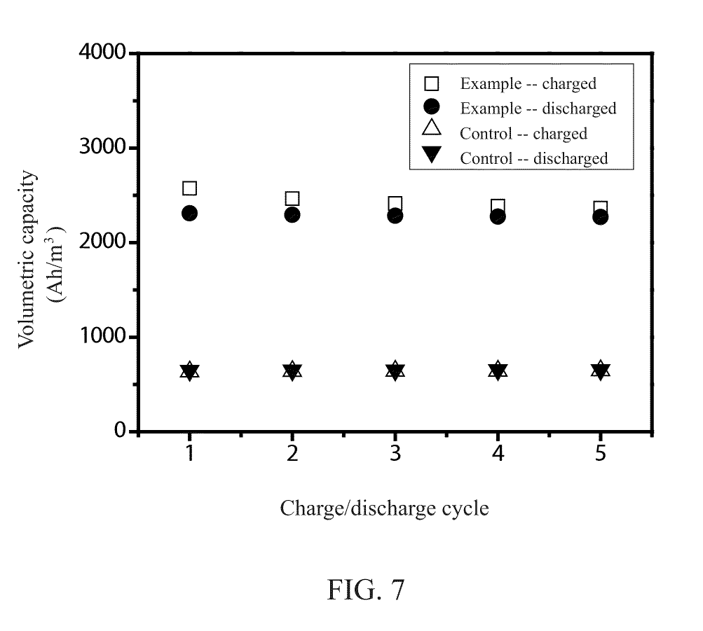

To further determine charge/discharge efficiency of the supercapacitor thus obtained, the supercapacitor and a prior lithium-ion battery (as control) are both charged to a full voltage, and then fully discharged. As shown in FIGS. 6 and 7, a charge/discharge cycle means every charge/discharge operation. It is learned that charge energy density and discharge energy density of the supercapacitor in the example after every charge/discharge cycle are both constant. It is further learned that charge energy density and discharge energy density of the supercapacitor in the example after every charge/discharge cycle both prevail over those of the prior lithium-ion battery. This implies that the supercapacitor in the example has a relatively great electric capacity and a relatively good charge/discharge efficiency.

As described in the example, it has been proven that the supercapacitor in the example has an electrical efficiency better than and/or equal to that of the prior supercapacitor and the prior battery. The outcome supposedly results from that the electrodes are free of any adhesive and electric impedance thereof is decreased.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A supercapacitor, comprising:
a pair of electrodes, each having a graphite fiber core and an activated carbon shell atomically coated on an outer surface of the core; and
an electrolyte positioned between the two electrodes and in touch with each shell for electrical connection of the two electrodes.

2. The supercapacitor as claimed in claim 1, wherein the electrolyte is a solid electrolyte.

3. The supercapacitor as claimed in claim 1, wherein the electrolyte is a liquid electrolyte.

4. The supercapacitor as claimed in claim 3 further comprising:
an isolation membrane positioned in the electrolyte to isolate the pair of electrodes for avoiding the electrodes from short circuit.

5. The supercapacitor as claimed in claim 2 further comprising:
a package provided to accommodate the electrodes and the electrolyte.

6. The supercapacitor as claimed in claim 4 further comprising:
a package provided to accommodate the electrodes, the electrolyte, and the isolation membrane.

7. The supercapacitor as claimed in claim 1, wherein each of the pair of electrodes is produced via a hot acid bathing process or a plasma induction process.

8. The supercapacitor as claimed in claim 1, wherein the core has a diameter of 100 μm to 500 μm.

9. The supercapacitor as claimed in claim 1, wherein the shell has a depth of 1 nm to 50 nm.

10. The supercapacitor as claimed in claim 4, wherein the isolation membrane is selected from the group consisting of a polyalkane non-woven fabric, a polyvinylchloride micro-porous membrane, an ebonite micro-porous membrane, and a glass fiber membrane.

11. The supercapacitor as claimed in claim 2, wherein the solid electrolyte is made of a conductive polymer, or a mixture containing the conductive polymer and an ionic compound.

12. The supercapacitor as claimed in claim 3, the liquid electrolyte is made of a solution containing a metal salt of group IA, or a molten salt of group IA.
